(19) United States
(12) Patent Application Publication
(10) Pub. No.: US 2025/0078354 A1
(43) Pub. Date: Mar. 6, 2025

(54) IMAGE PROCESSING METHOD AND APPARATUS, DEVICE, STORAGE MEDIUM AND PROGRAM PRODUCT

(71) Applicant: BEIJING BYTEDANCE NETWORK TECHNOLOGY CO., LTD., Beijing (CN)

(72) Inventor: Guanjun GUO, Beijing (CN)

(21) Appl. No.: 18/704,432

(22) PCT Filed: Nov. 2, 2022
(86) PCT No.: PCT/CN2022/129170

§ 371 Date: Nov. 22, 2024

(30) Foreign Application Priority Data
Nov. 5, 2021 (CN) 202111308491.2

(51) Int. Cl. G06T 11/60

(52) U.S. Cl. CPC G06T 11/60

(57) ABSTRACT

Disclosed in embodiments of the present disclosure are an image processing method and apparatus, a device, a storage medium and a program product. The image processing method includes: determining N text regions and M text pattern types of an image to be processed; rendering one or more text regions of the N text regions by using one or more text pattern types of the M text pattern types to obtain one or more first rendered images; inputting the one or more first rendered images into a scoring model to obtain scores of the one or more first rendered images; and determining a target image based on the scores of the one or more first rendered images.

### CROSS-REFERENCE TO RELATED APPLICATIONS

The present application is a U.S. National Stage Application under 35 U.S.C. § 371 of International Patent Application No. PCT/CN2022/129170, filed on Nov. 2, 2022, which claims priority to China Patent Application No. 202111308491.2 filed on Nov. 5, 2021, the disclosures of both of which are incorporated by reference herein in their entireties.

### TECHNICAL FIELD

The present disclosure relates to an image processing method and apparatus, a device, a storage medium, and a program product.

### BACKGROUND

With the progress of science and technology, the development of video technology is becoming more and more mature. In common video websites or applications, video recommendation is made by showing recommended images to users.

### SUMMARY

In a first aspect, an embodiment of the present disclosure provides an image processing method, comprising: determining N text regions and M text pattern types of an image to be processed, wherein N and M are integers greater than or equal to 1, and N is greater than or equal to M; rendering one or more text regions of the N text regions by using one or more text pattern types of the M text pattern types to obtain one or more first rendered images; inputting the one or more first rendered images into a scoring model to obtain scores of the one or more first rendered images; and determining a target image based on the scores of the one or more first rendered images.

In a second aspect, an embodiment of the present disclosure provides an image processing apparatus, comprising: a text region and color determination module configured to determine N text regions and M text pattern types of an image to be processed, wherein N and M are integers greater than or equal to 1, and N is greater than or equal to M; a first rendering module configured to render one or more text regions of the N text regions by using one or more text pattern types of the M text pattern types to obtain one or more first rendered images; a score determination module configured to input the one or more first rendered images into a scoring model to obtain scores of the one or more first rendered images; and a target image determination module configured to determine a target image based on the scores of the one or more first rendered images.

In a third aspect, an embodiment of the present disclosure provides an electronic device, comprising: one or more processors; and a storage device configured to store one or more programs that, when executed by the one or more processors, cause the one or more processors to implement the image processing method according to any embodiments of the first aspect.

In a fourth aspect, an embodiment of the present disclosure provides a computer-readable storage medium stored thereon a computer program that, when executed by a processor, implements the image processing method according to any embodiments of the first aspect.

In a fifth aspect, an embodiment of the present disclosure provides a computer program product comprising computer programs or instructions that, when executed by a processor, implement the image processing method according to any embodiments of the first aspect.

In a sixth aspect, an embodiment of the present disclosure provides a computer program, comprising: instructions that, when executed by a processor, cause the processor to perform the image processing method according to any embodiments of the first aspect.

### BRIEF DESCRIPTION OF THE DRAWINGS

The above and other features, advantages, and aspects of the embodiments of the present disclosure will become more apparent from the following embodiments with reference to the drawings. Throughout the drawings, the same or similar reference signs indicate the same or similar elements. It should be understood that the drawings are schematic and the components and elements are not necessarily drawn to scale.

FIG. 1 is a flowchart of an image processing method in an embodiment of the present disclosure;

FIG. 2 is a schematic diagram of N text regions in an embodiment of the present disclosure;

FIG. 3 is a flowchart of an image processing method in an embodiment of the present disclosure;

FIG. 4 is a flowchart of an image processing method in an embodiment of the present disclosure;

FIG. 5 is a flowchart of an image processing method in an embodiment of the present disclosure;

FIG. 6 is a schematic diagram of a deduction item in an embodiment of the present disclosure;

FIG. 7 is a schematic structural diagram of an image processing apparatus in an embodiment of the present disclosure;

FIG. 8 is a schematic structural diagram of an electronic device in an embodiment of the present disclosure.

### DETAILED DESCRIPTION

Exemplary embodiments of the present disclosure will be described in detail below with reference to the accompanying drawings. Although some embodiments of the present disclosure are shown, it should be understood that the present disclosure can be implemented in various forms, and should not be construed as being limited to the embodiments set forth herein. On the contrary, these embodiments are provided for a more thorough and complete understanding of the present disclosure. It should be understood that the drawings and embodiments of the present disclosure are only used for exemplary purposes, and are not used to limit the scope of protection of the present disclosure.

It should be understood that the various steps described in the methods of the embodiments of the present disclosure may be executed in a different order, and/or executed in parallel. In addition, the methods may comprise additional steps and/or some of the illustrated steps may be omitted. The scope of the present disclosure is not limited in this regard.

The term “comprising” and its variants as used herein is an open-ended mode expression, that is, “comprising but not limited to”. The term “based on” means “based at least in part on”. The term “one embodiment” means “at least one embodiment”; the term “another embodiment” means “at least one additional embodiment”; the term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order of functions performed by these devices, modules or units, or interdependence therebetween.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

With the continuous development of Internet technology, adding text effects to a given image is widely used in games, videos, music, shopping websites, advertising design and other applications.

The inventor of the present disclosure has found that, in the related art, recommendation images displayed to users need to be rendered manually by post-production staff, but the efficiency of manual rendering is low.

In view of this, embodiments of the present disclosure provide an image processing method and apparatus, a device, a storage medium and a program product capable of harmoniously and aesthetically placing given text in an image to achieve the fast rendering of the image.

An embodiment of the present disclosure provides an image processing method suitable for various application scenarios. For example, it can be applied in video applications, such as audiovisual applications or short video applications. Specifically, a client receives a video uploaded by a user, select a frame from the video as a cover background image, and determine text to be added to the cover background image. The above text are added to the cover background image using the image processing method provided in an embodiment of the present disclosure to form a cover of the video.

For another example, it can also be used in shopping or advertising design applications. Specifically, a client receives a commodity image and a commodity description text uploaded by a user, and add the above commodity description text to the commodity image using the image processing method provided in the embodiment of the present disclosure to form a commodity image or an advertising design image with a text description.

It can be understood that the image processing method provided in the embodiment of the present disclosure is not limited to the application scenarios described above, and the above application scenarios are only for illustration purposes.

The following is a detailed introduction to the image processing method provided in an embodiment of the present application with reference to the accompanying drawings.

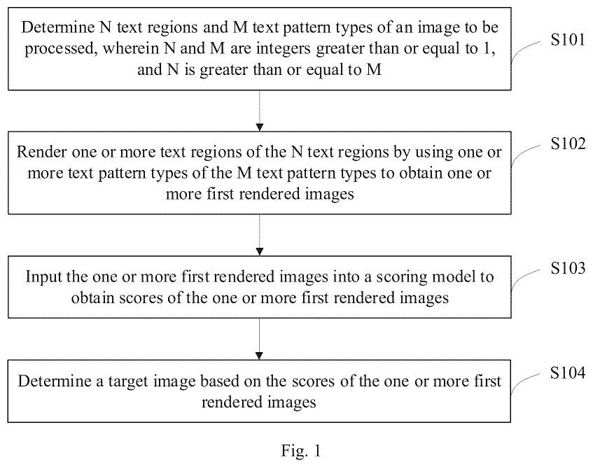

FIG. 1 is a flowchart of an image processing method in an embodiment of the present disclosure. The embodiment can be applicable to adding text effects to any image, and can be performed by an image processing apparatus, wherein the image processing apparatus can be implemented in software and/or hardware, and can be configured in an electronic device.

For example, the electronic device can comprise mobile terminal, a fixed terminal or a portable terminal, such as a mobile phone, a website, a unit, a device, a multimedia computer, a multimedia tablet, an Internet node, a communicator, a desktop computer, a laptop computer, a netbook computer, a tablet computer, a personal communication system (PCS) device, a personal navigation device, a personal digital assistant (PDA), an audio/video player, a digital camera/video camera, a positioning device, a television receiver, a radio broadcast receiver, an e-book device, a gaming device or any combination thereof, comprising accessories and peripherals of these devices or any combination thereof.

For another example, the electronic device may be a server, wherein the server can be a physical server or a cloud server; the server can be a server, or a server cluster.

As shown in FIG. 1, the image processing method provided in an embodiment of the present disclosure comprises the following steps S101 to S104.

In step S101, N text regions and M text pattern types of an image to be processed are determined, wherein N and M are integers greater than or equal to 1, and N is greater than or equal to M.

The image to be processed can be any given image. For example, it can be a photo to which text needs to be added, or any video frame extracted from a video, or a commodity image that needs advertising design, and so on.

In an embodiment, the image to be processed may be an image uploaded directly by a user, for example in a shopping website, an advertising design website, a photo design website, or an image directly uploaded by the user to the client.

In another embodiment, the image to be processed may be an image to be processed determined from a video uploaded by the user. For example, it can be a video frame randomly selected from the above video, or a video frame designated by the user, or it may be an image created by concatenating multiple video frames.

In another embodiment, the image to be processed may be an image selected from an image library based on text information uploaded by the user. For example, in music applications, based on a song list selected by the user, a photo of the singer of a song in the song list can be taken as the image to be processed.

It should be noted that in the embodiment, the description of the selection of the image to be processed is only by way of illustration, not limitation.

The text region can be understood as a connected region where text will be added to the image to be processed. Specifically, the text region is a region where a main body of the image will not be blocked after adding text to the image to be processed. For example, the text region cannot be a face region in the image to be processed. The N text regions refer to N connected regions of text, that is, N connected regions at different positions. FIG. 2 shows text connected regions disposed at N positions.

The text added to the text region can be the text input by the user and received by the client, such as a description given by the user for a commodity in the commodity image. The text added to the text region can be a title of a video extracted by the client. For example, if the image to be processed is a video frame, the text can be a title of a movie or TV show.

Further, the above text can comprise any existing written text characters such as Chinese characters, English letters, Korean characters, Greek letters, Arabic numerals, etc., and can also be any written symbol such as “%”, “@”, “&”, etc.

In an embodiment, N connected regions of the image to be processed are arbitrarily selected as text regions of the image to be processed.

In one embodiment, the image to be processed is input into a pre-trained image-text matching model to determine a target template corresponding to the image to be processed. Based on a position of a text region in the target template, the positions of N text regions are determined.

The pattern type can be understood as a special effect for text fillings or borders. Optionally, a target pattern type can be any one or more of a target color, a target texture, a target effect, etc. The target color can be a color corresponding to a color value or a gradient color corresponding to multiple color values. The target texture can be understood as a text filling texture, wherein the target texture can be a system default texture, or the target texture can be determined in response to a texture selection operation of the user. The target effect can be one or more combinations of adding shadows, reflections, adding text borders, lighting, three-dimensional effects, or the like.

Further, the text pattern types in the text regions can be the same or different, which is not specifically limited in the embodiment.

In step S102, one or more text regions of the N text regions are rendered by using one or more text pattern types of the M text pattern types to obtain one or more first rendered images. In the embodiments of the present disclosure, the term “one or more” means “at least one”, and the following is similar.

FIG. 2 is a schematic diagram of N text regions provided in an embodiment of the present disclosure. As shown in FIG. 2, an image can comprise N text regions: text region 1, text region 2, . . . , text region n. One or more text regions are rendered by using one or more text pattern types to obtain one or more first rendered images.

For example, one text region is rendered by using m text pattern types. For example, the text region 1 is rendered by using m text pattern types to obtain m first rendered images, where m is less than or equal to M. Those m first rendered images obtained in this way are images with different text pattern types in the same text region.

For example, n text regions are rendered by using one text pattern type to obtain n first rendered images, wherein n is less than or equal to N. Those n first rendered images obtained in this way are images with text of the same text pattern type distributed in different regions of the image.

For example, n text regions are rendered by using m text pattern types respectively to obtain n*m first rendered images, where n is less than or equal to N, and m is less than or equal to M.

Specifically, the text region 1 is rendered by using m text pattern types respectively to obtain m first rendered images; the text region 2 is rendered by using m text pattern types respectively to obtain m first rendered images; . . . ; the text region n is rendered by using m text pattern types respectively to obtain m first rendered images. Thus, the n text regions are rendered by using m text pattern types respectively to obtain n*m first rendered images.

In step S103, the one or more first rendered images are input into a scoring model to obtain scores of the one or more first rendered images.

In the embodiment, each first rendered image is scored by the scoring model, and a target image is determined based on the scoring result.

In S104, a target image is determined based on the scores of the one or more first rendered images.

The target image can be used as a cover image of a video, a cover image of a song list, or a commodity promotion image.

In an embodiment, the determining of the target image based on the scores of the one or more first rendered images comprises: inputting the one or more first rendered images into the scoring model to obtain scores for each of the first rendered images; sorting the scores in descending order and displaying the first rendered images at the top on the client, and determining the target image in response to the user's selection operation on the first rendered images.

In the embodiment, X first rendered images at the top are displayed to the user to enable the user to select the target image, which allows the user to choose the target image according to the preference of the user.

In an embodiment, a first rendered image having the highest score is determined as the target image, which can avoid the problem of manual rendering of the recommendation image by post-production staff. The given text can be harmoniously and aesthetically placed in the image, thereby achieving the fast rendering of the image.

An embodiment of the present disclosure provides an image processing method, comprising: determining N text regions and M text pattern types of an image to be processed; rendering one or more text regions of the N text regions by using one or more text pattern types of the M text pattern types to obtain one or more first rendered images; inputting the one or more first rendered images into a scoring model to obtain scores of the one or more first rendered images; and determining a target image based on the scores of the one or more first rendered images. In the embodiment of the present disclosure, after rendering the image based on a plurality of text regions and text pattern types, the rendered images are scored to obtain a target image. The given text is harmoniously and aesthetically placed in the image, thereby achieving the fast rendering of the image, and avoiding the problem of manual rendering of the recommendation image by post-production staff.

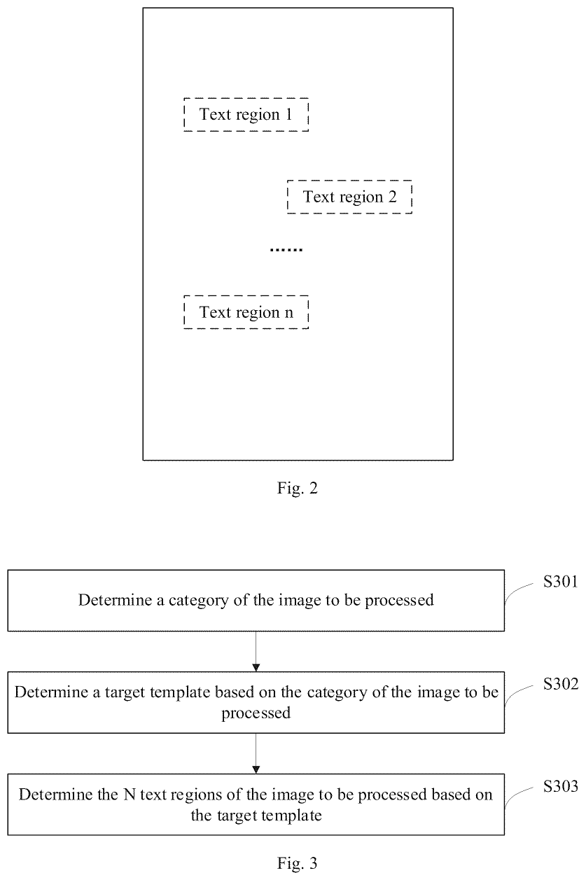

On the basis of the above embodiment, the embodiment of the present disclosure optimizes the process of determining the N text regions in the image to be processed. As shown in FIG. 3, the optimized process mainly comprises steps S301 to S303.

In step S301, a category of the image to be processed is determined.

In the embodiment, the category of the image to be processed is mainly determined based on a main body in the image. Optionally, the category of the image may comprise: a person, a beach, a building, a car, a cartoon, a cat, a dog, a flower, a thing, a group photo, a mountain peak, an indoor scene, a lake (comprising a sea), a night scene, a selfie, sky, a sculpture, a street view, a sunset, a text, a tree, etc. The category of the image is mainly used to classify the images to be processed.

Further, the category of the image to be processed can be obtained from tag information of the image to be processed, or a main body feature can be extracted from the image to be processed by an image recognition method, and the category of the image to be processed can be determined based on the main body feature.

For example, if a main body feature extracted from the image to be processed is a building, it is determined that the category of the image to be processed is the building.

In step S302, a target template is determined based on the category of the image to be processed.

The target template can be understood as a reference image for rendering the image to be processed, that is, the position of a text region in the image to be processed can be determined by referring to the target template. Specifically, a template is one or more images with text added and having template information that describes relevant information of the image(s).

Further, the template comprises a template background image and template information. The template background image can understood as one or more images with text added. The template information comprises a template ID (identifier), a template title, a text font size, a text line number, a font name, a font size, a text pattern type color matching rule, or a template classification tag.

Further, a category of the template can be obtained by reading the template classification tag in the template information; and a template whose category is consistent with the category of the image to be processed is determined as the target template.

For example, if the category of the image to be processed is a person, a template whose template type is a person can be determined as the target template. If the category of the image to be processed is a sea, a template whose template type is a sea can be determined as the target template.

It should be noted that the target template can be one template or multiple templates, which is not specifically limited in the embodiment.

In an embodiment, the determining of the target template based on the category of the image to be processed comprises: determining a template candidate set based on the category of the image to be processed and template information; and selecting the target template corresponding to the image to be processed from the template candidate set.

In the embodiment, a template consistent with the category of the image to be processed is found in a template library and determined as a template candidate set. In the embodiment, some templates are filtered out based on the category of the image to be processed, and the target template is selected from a limited set, thereby reducing the range of template selection and improving the efficiency of template selection.

In an embodiment, any template in the template candidate set can be selected as the target template.

In an embodiment, the selecting of the target template corresponding to the image to be processed from the template candidate set comprises: determining an image matching degree between the template background image and the image to be processed for one or more templates in the template candidate set; determining an image-text matching degree between the template information and the image to be processed; and determining the target template corresponding to the image to be processed based on the image matching degree and/or the image-text matching degree.

The image matching degree D_ii can be understood as the degree of similarity between the template background image and the image to be processed, wherein the higher the image matching degree, the higher the degree of similarity between the two images.

The image-text matching degree D_it can be understood as the degree of matching between a language description and an image. The higher the image-text matching degree D_it, the higher the degree of similarity between the language description and the image. For example, if the language description is “an elephant and a forest” and the image shows a sea, the image-text matching degree D_it is low. If the language description is “an elephant and a forest” and the image shows an elephant resting in a forest, the image-text matching degree D_it is high.

The determining of the target template corresponding to the image to be processed based on the image matching degree comprises: determining a template with a highest image matching degree as the target template corresponding to the image to be processed.

The determining of the target template corresponding to the image to be processed based on the image-text matching degree comprises: determining a template with a highest image-text matching degree as the target template corresponding to the image to be processed.

The determining of the target template corresponding to the image to be processed based on the image matching degree and the image-text matching degree comprises: summing the image matching degree and the image-text matching degree, and determining a template corresponding to a maximum sum value as the target template.

The way of calculating the image matching degree and the image-text matching degree will not be described in the embodiment.

In the embodiment, the target template is determined based on a distance between images and a distance between an image a text, so that the target template is highly similar to the image to be processed, and the image rendering effect can be improved.

In step S303, the N text regions of the image to be processed are determined based on the target template.

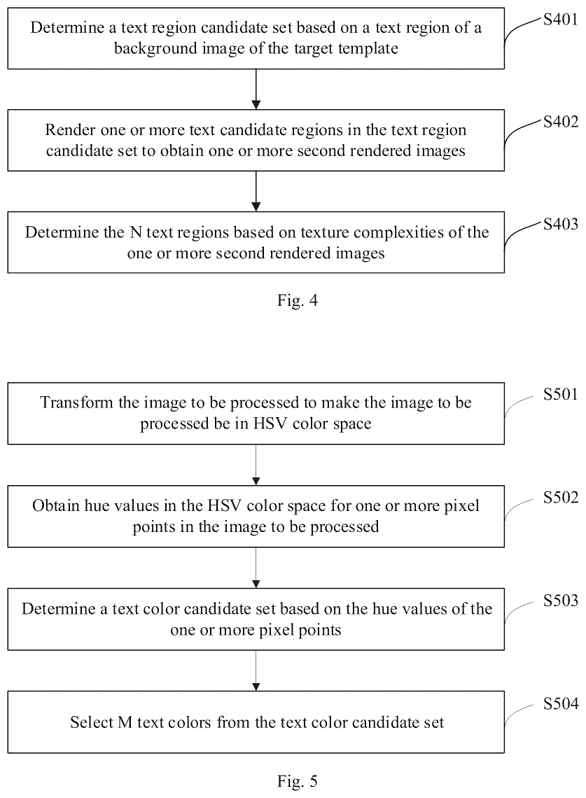

On the basis of the above embodiments, the embodiment of the present disclosure optimizes the process of determining the N text regions of the image to be processed based on the target template. As shown in FIG. 4, the optimized process mainly comprises steps S401 to S403.

In step S401, a text region candidate set is determined based on a text region of a background image of the target template.

In the embodiment, relevant information of the text region is obtained from the target template information and the background image of the target template.

For example, a text font size, a text line number, a font name, and a font size are determined by reading the target template information, and are directly used as an attribute of text in the text region.

Further, a size of the text region is determined based on the number of text words and the text font size. The text font size is a font size of the text in the target template. Further, a product of a width of a single text word corresponding to the text font size and the number of text words is used as a width of the text region, and a height of a single text word corresponding to the text font size is used as a height of the text region.

Further, a position of the text region in the target template is determined, and the position of the text region in the target template is adjusted to obtain a plurality of text region positions, wherein the plurality of text region positions are used as a text region candidate set.

For example, if the text region in the target template is centered in the template background image, the position of the text region is adjusted to obtain a plurality of text region positions. For example, the position can be moved 10 pixels left, 10 pixels right, 10 pixels up, 10 pixels down, etc. The specific adjustment strategy in the embodiment is for illustration only and is not a limitation.

In step S402, one or more text candidate regions in the text region candidate set are rendered to obtain one or more second rendered images.

In the embodiment, one or more text candidate regions are rendered to the image to be processed by using a same pattern type to obtain one or more second rendered images. The same pattern type described above can be any color or texture, and is not limited in the embodiment. Optionally, the same pattern type described above is black or white.

In step S403, the N text regions are determined based on texture complexities of the one or more second rendered images.

In an embodiment, for the one or more second rendered images, a texture complexity of the text region in each of the one or more second rendered images is determined to obtain a texture complexity corresponding to each second rendered image.

The above texture complexities are sorted in descending order, and the text candidate regions with the top N texture complexities are determined as the text regions.

In an embodiment, the determining of the N text regions based on texture complexities of the one or more second rendered images comprises: for the one or more second rendered images, determining the texture complexities of the text candidate regions of the one or more second rendered images; inputting the one or more second rendered images into the scoring model to obtain first scoring results; and determining the N text regions based on the texture complexities and the first scoring results.

In an embodiment, the determining of the N text regions based on the texture complexities and the first scoring results comprises: for the one or more second rendered images, determining first weighted values calculated based on the texture complexities and the first scoring results; sorting the first weighted values in descending order; and determining text candidate regions corresponding to top N first weighted values as the text regions.

In the embodiment, each of the one or more second rendered images is input into the scoring model to obtain a first scoring result of the second rendered image; a texture complexity is also calculated for the text region of the second rendered image; the first scoring result and the texture complexity are weighted to obtain a first weighted value. The above operations are performed for a plurality of second rendered images to obtain a plurality of first weighted values, and the plurality of first weighted values are sorted in descending order. Text candidate regions corresponding to the top N first weighted values are used as the N text regions.

On the basis of the above embodiment, the embodiment of the present disclosure optimizes the process of determining the M text pattern types of the image to be processed. As shown in FIG. 5, the optimized process mainly comprises steps S501 to S504.

In step S501, the image to be processed is transformed to make the image to be processed be in HSV color space.

In the HSV color space, a color is represented by three parameters: Hue (H), Saturation (S), and Value (V). The HSV color space is a three-dimensional representation of the RGB color system.

The Hue (H) component is measured in degrees, with a range of values from 0° to 360°. It is calculated counterclockwise from Red, where Red is 0°, Green is 120°, and Blue is 240°. Their complementary colors are Yellow at 60°, Cyan at 180°, and Purple at 300°.

The hue component in HSV color space of the entire image to be rendered is extracted from the background color information of the image to be rendered.

In step S502, hue values in the HSV color space is obtained for one or more pixel points (i.e., at least one pixel) in the image to be processed.

In an embodiment, the entire image to be rendered is transformed to make the entire image to be rendered be in the HSV color space to obtain the hue value in the HSV color space.

In another implementation, an image corresponding to a text region in the image to be rendered is transformed to make the image be in the HSV color space to obtain the hue value in the HSV color space.

In step S503, a text color candidate set is determined based on the hue values of the one or more pixel points.

a text target color is determined based on an average value H_Avg of the hue component, an average value S_Avg of the saturation component, and an average value V_Avg of the value component.

In the embodiment, the hue value is extracted from the image to be rendered, or from an image corresponding to a text region of the image to be rendered, and a hue average value corresponding to a plurality of pixels is calculated to obtain the hue average value H_Avg.

All colors corresponding to a color value are found from the set S of all colors as the text color candidate set O, wherein the difference between the color value and the hue average value H_Avg is minimal in the dimension of H value. The minimal difference in H value ensures that the text color looks harmonious and beautiful.

In step S504, M text colors are selected from the text color candidate set.

In the embodiment, it is possible to arbitrarily select M colors from the color candidate set. It is also possible to determine M text pattern types based on colors selected from the color candidate set that have saturation values greater than a saturation threshold or values greater than a value threshold.

In the above embodiment, N text regions are determined, and one or more text regions of the N text regions are rendered by using one or more text candidate colors in the text color candidate set, so that one or more third rendered images can be obtained for each text region, and a text color corresponding to the text region is determined based on the one or more third rendered images. The above operation is repeated on the N text regions to obtain N text colors. M text colors are determined from the N text colors.

In an embodiment, the selecting of the M text colors from the text color candidate set comprises: rendering the one or more text regions by using one or more text candidate colors in the text color candidate set to obtain a plurality of third rendered images; and determining the M text colors based on background contrasts of the plurality of third rendered images.

In the embodiment, the text region 1 is rendered respectively by using a plurality of text candidate colors to obtain a plurality of third rendered images, and a background contrast is determined for the text region in each third rendered image. A text candidate color used in the third rendered image with the highest background contrast is determined as the text color.

Further, one text color is determined for one text region, N text colors are determined for N text regions, and M text colors are selected from the N text colors.

In an embodiment, the determining of the M text colors based on the background contrasts of the plurality of third rendered images comprises: for one or more third rendered images, determining the background contrasts of the text regions in the one or more third rendered images; inputting the one or more third rendered images into the scoring model to obtain second scoring results; determining second weighted values calculated based on the background contrasts and the second scoring results; and determining the M text colors corresponding to the text regions based on the second weighted values.

In the embodiment, the text region 1 is rendered respectively by using a plurality of text candidate colors to obtain a plurality of third rendered images, and a background contrast of the text region in each third rendered image is determined. In addition, each third rendered image is input into the scoring model to obtain a second scoring result corresponding to the third rendered image; the second scoring result and the background contrast are weighted to obtain a second weighted value. The above operation is repeated on a plurality of third rendered images to obtain a plurality of second weighted values. a color corresponding to the maximum weighted value of the plurality of weighted values is determined as the text color corresponding to the text region. The above operation is performed for the N text regions to obtain N text colors.

In the embodiment, N text color values are compared, and only one color is retained for colors with the same color value to filter out colors with the same color value, so that M different text colors are obtained, where M is less than N.

In the embodiment, the N text pattern type values are compared. If all the text pattern type values are different, M text pattern types are directly determined from the N text pattern types, where M is equal to N.

In an embodiment, a training method for the scoring model comprises: performing data labeling on a sample image based on an image quality of the sample image; and performing training using the sample image after data labeling to obtain the scoring model.

In the embodiment, data labeling is first performed, wherein the data labeling is generally a subjective process. Here, an objective/subjective data labeling process is constructed to separate the objectively labeled parts of the data and improve the accuracy of data labeling. After data labeling, a 5-class classification model is trained using the data, but the scoring model is obtained by averaging the scores of 5 classes and mapping them to a corresponding scores.

In the embodiment, the sample image is scored based on the quality of the sample image. If an image of the sample image is displayed incorrectly, or the image is particularly blurry, or is a rotated image, the label is discarded. An image with background blur is not considered blurred. The correlation between the text content and the image is not considered, only whether the text region can make the whole image harmonious and beautiful. Only text with the first 3 font sizes in the image is considered, while other texts or font sizes that are too small are not considered.

Further, scoring is performed in the subjective dimension. For example, A text region that makes the whole composition harmonious and beautiful is usually placed in a position opposite to the main body or in a blank space, and its score can be increased or decreased accordingly, which can be predetermined in the label process.

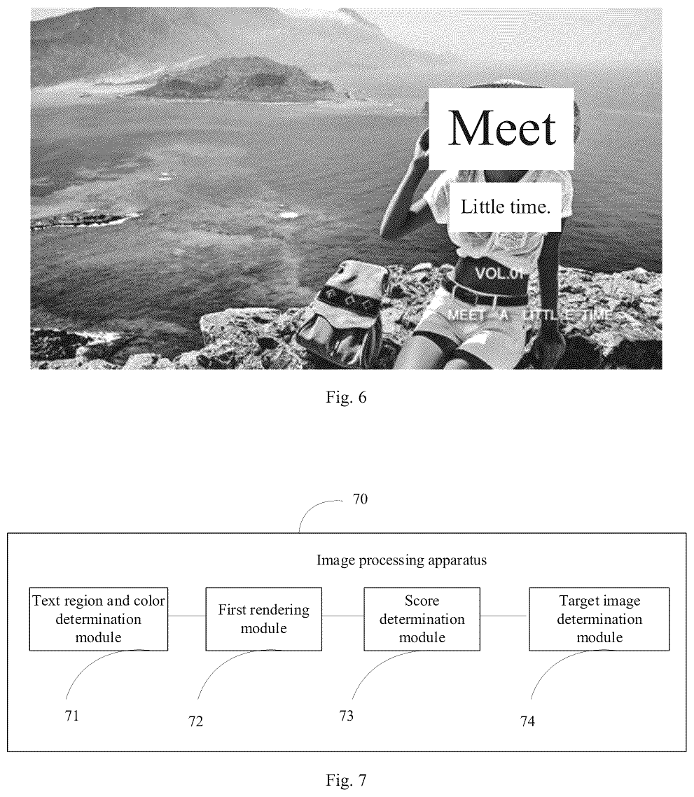

Further, a deduction can be set in the objective dimension. For example, if the text obstructs a significant object in the image (e.g., it obstructs the eyes or occupies more than half of the total area, as shown in FIG. 6), the preset score can be deducted according to the obstruction range; if the image contains both a main person and a non-main person, the obstruction of the non-main person does not need to be taken into account, and the latter conditions can be considered. If the title is too small or there is no title, the preset score will be deducted; or if the texts overlap, the preset score is deducted according to the overlapping rate of the texts. If the text pattern type is similar to the background color of the area where the text is located, the preset score is deducted based on the degree of color similarity. If the main body is centered in the image and the text is offset to the left or right, or if both the text and the main body are on one side of the image, which makes the overall composition of the image unbalanced, the preset score is deducted.

FIG. 7 is a schematic structural diagram of an image processing apparatus in an embodiment of the present disclosure. The embodiment can be applicable to adding a text effect to any image. The image processing apparatus can be implemented in software and/or hardware. The image processing apparatus can be configured in an electronic device.

As shown in FIG. 7, the image processing apparatus 70 provided in the embodiment of the present disclosure mainly comprises: a text region and color determination module 71, a first rendering module 72, a score determination module 73, and a target image determination module 74.

The text region and color determination module 71 is configured to determine N text regions and M text pattern types of an image to be processed, wherein N and M are integers greater than or equal to 1, and N is greater than or equal to M.

The first rendering module 72 is configured to render one or more text regions of the N text regions by using one or more text pattern types of the M text pattern types to obtain one or more first rendered images.

The score determination module 73 is configured to input the one or more first rendered images into a scoring model to obtain scores of the one or more first rendered images.

The target image determination module 74 is configured to determine a target image based on the scores of the one or more first rendered images.

An embodiment of the present disclosure provides an image processing apparatus for performing the following steps: determining N text regions and M text pattern types of an image to be processed; rendering one or more text regions of the N text regions by using one or more text pattern types of the M text pattern types to obtain one or more first rendered images; inputting the one or more first rendered images into a scoring model to obtain scores of the one or more first rendered images; and determining a target image based on the scores of the one or more first rendered images. In the embodiment of the present disclosure, after rendering the image by using a plurality of text regions and text pattern types, the rendered images are scored to obtain a target image. The given text can be harmoniously and aesthetically placed in the image, thereby achieving the fast rendering of the image, and avoiding the problem of manual rendering of the recommendation image by post-production staff.

In an embodiment, the text region and color determination module comprises a text region determination module and a text pattern type determination module.

In an embodiment, the text region determination module comprises: an image category determination unit configured to determine a category of the image to be processed; a target template determination unit configured to determine a target template based on the category of the image to be processed; and a text region determination unit configured to determine the N text regions of the image to be processed based on the target template.

In an embodiment, the target template determination unit is configured to determine a template candidate set based on the category of the image to be processed and template information, and select the target template corresponding to the image to be processed from the template candidate set.

In an embodiment, the template comprises a template background image. The target template determination unit is configured to determine an image matching degree between the template background image and the image to be processed for one or more templates in the template candidate set, determine an image-text matching degree between the template information and the image to be processed, and determine the target template corresponding to the image to be processed based on the image matching degree and/or the image-text matching degree.

In an embodiment, the text region determination unit is configured to determine a text region candidate set based on a text region of a background image of the target template, render one or more text candidate regions in the text region candidate set to obtain one or more second rendered images, and determine the N text regions based on texture complexities of the one or more second rendered images.

In an embodiment, the text region determination unit is configured to determine the N text regions based on the texture complexities of the one or more second rendered images, comprising: for the one or more second rendered images, determining the texture complexities of the text candidate regions of the one or more second rendered images; inputting the one or more second rendered images into the scoring model to obtain first scoring results; and determining the N text regions based on the texture complexities and the first scoring results.

In an embodiment, the text region determination unit is configured to, for the one or more second rendered images, determine first weighted values calculated based on the texture complexities and the first scoring results, sort the first weighted values in descending order, and determine text candidate regions corresponding to top N first weighted values as the text regions.

In an embodiment, the text pattern type determination module comprises: an image transforming unit configured to transform the image to be processed to make the image to be processed be in HSV color space; a hue value extraction unit configured to obtain hue values in the HSV color space for one or more pixel points in the image to be processed; a text color candidate set determination unit configured to determine a text color candidate set based on the hue values of the one or more pixel points; and a text color determination unit configured to select M text colors from the text color candidate set.

In an embodiment, the text color determination unit is configured to select the M text colors from the text color candidate set, comprising: rendering the one or more text regions by using one or more text candidate colors in the text color candidate set to obtain a plurality of third rendered images; and determining the M text colors based on background contrasts of the plurality of third rendered images.

In an embodiment, the text color determination unit is configured to, for one or more third rendered images, determine the background contrasts of the text regions in the one or more third rendered images, input the one or more third rendered images into the scoring model to obtain second scoring results, determine second weighted values calculated based on the background contrasts and the second scoring results, and determine the M text colors corresponding to the text regions based on the second weighted values.

In an embodiment, the apparatus further comprises: a scoring module training module configured to perform data labeling on a sample image based on an image quality of the sample image, and perform training using the sample image after data labeling to obtain the scoring model.

The image processing apparatus provided in the embodiment of the present disclosure can perform the steps of the image processing method provided in an embodiment of the present disclosure. The steps involved and the beneficial effect achieved will not be described in detail.

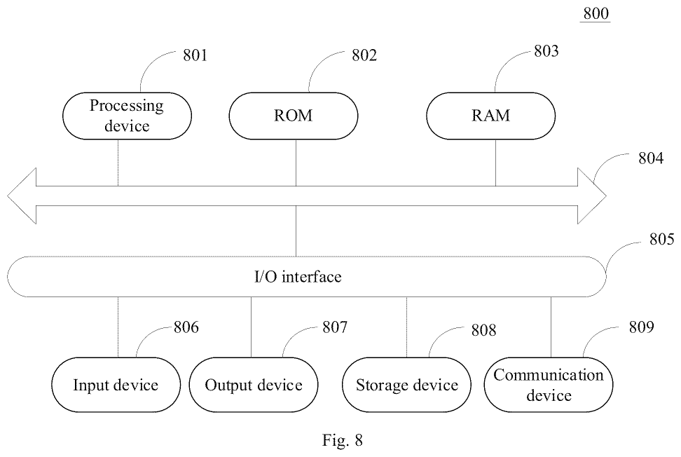

FIG. 8 is a schematic structural diagram of an electronic device in an embodiment of the present disclosure. Referring to FIG. 8, a schematic structural diagram of an electronic device 800 suitable for implementing the embodiments of the present disclosure is shown. The electronic device 800 of the embodiment of the present disclosure may comprise, but not limited to, a mobile terminal such as a mobile phone, a notebook computer, a digital broadcast receiver, a PDA (Personal Digital Assistant), a PAD (tablet computer), a PMP (Portable Multimedia Player), an on-board terminal (such as an on-board navigation terminal), or a wearable electronic device, and a fixed terminal such as a digital TV, a desktop computer, or a smart-home device. The terminal device shown in FIG. 8 is merely an example and should not impose any limitation on the function and application scope of the embodiments of the present disclosure.

As shown in FIG. 8, the electronic device 800 may comprise a processing device (e.g., a central processing unit, a graphics processor) 801, which may perform various appropriate actions and processes to implement the image processing method of the embodiment of the present disclosure according to a program stored in Read Only Memory (ROM) 802 or a program loaded from storage device 808 into Random Access Memory (RAM) 803. In RAM 803, various programs and data required for the operation of the terminal device 800 are also stored. The processing device 801, ROM 802, and RAM 803 are connected to each other through a bus 804. An input/output (I/O) interface 805 is also connected to the bus 804.

Generally, the following devices can be connected to the I/O interface 805: an input device 806 comprising, for example, a touch screen, a touch pad, a keyboard, a mouse, a camera, a microphone, an accelerometer, a gyroscope, etc.; an output device 807 comprising, for example, a liquid crystal display (LCD), a speaker, a vibrator, etc.; a storage device 808 comprising, for example, a magnetic tape, a hard disk, etc.; and a communication device 809. The communication device 809 enables the terminal device 800 to communicate in a wireless or wired manner with other devices to exchange data. Although FIG. 8 shows the terminal device 800 with various components, it should be understood that it is not required to implement or have all of these components. Alternatively, more or fewer components can be implemented or provided.

In particular, according to an embodiment of the present disclosure, the processes described above with reference to the flowchart can be implemented as a computer software program. For example, an embodiment of the present disclosure comprises a computer program product, which comprises a computer program carried on a non-transitory computer readable medium, and containing program code for executing the method shown in the flowchart to implement the above image processing method. In such an embodiment, the computer program may be downloaded and installed from the network through the communication device 809, or installed from the storage device 808, or from the ROM 802. When the computer program is executed by the processing device 801, the above functions defined in the method of the embodiment of the present disclosure are performed.

It should be noted that the computer readable medium in the present disclosure may be a computer readable signal medium or a computer readable storage medium, or any combination of thereof. The computer readable storage medium can be, for example, but not limited to, an electronic, magnetic, optical, electromagnetic, infrared, or semiconductor system, apparatus, or device, or any combination of the above. More specific examples of the computer readable storage medium may comprise, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In the present disclosure, the computer readable storage medium can be any tangible medium that can contain or store a program, which can be used by or in connection with an instruction execution system, apparatus or device. In the present disclosure, the computer readable signal medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on the computer readable medium can be transmitted by any suitable medium, comprising but not limited to wire, fiber optic cable, RF (radio frequency), etc., or any suitable combination of the foregoing.

In some embodiments, a client and a server can communicate using any currently known or future developed network protocol such as HTTP (HyperText Transfer Protocol), and can be interconnected by any form or medium of digital data communication, e.g., a communication network. Examples of communication networks comprise a local area network (“LAN”) and a wide area network (“WAN”), the Internet (for example, Internet), and end-to-end networks (for example, ad hoc end-to-end networks), as well as any currently known or future developed networks.

The above computer readable medium may be comprised in the electronic device described above; or it may exist alone without being assembled into the electronic device. For example, the computer readable storage medium is a non-transitory computer readable storage medium.

The computer readable medium carries one or more programs that, when executed by the terminal device, cause the terminal device to: determine N text regions and M text pattern types of an image to be processed, wherein N and M are integers greater than or equal to 1, and N is greater than or equal to M; render one or more text regions of the N text regions by using one or more text pattern types of the M text pattern types to obtain one or more first rendered images; input the one or more first rendered images into a scoring model to obtain scores of the one or more first rendered images; and determine a target image based on the scores of the one or more first rendered images.

Optionally, when the terminal device performs the above one or more programs, the terminal device may also perform other steps in the above embodiments.

The computer program code for executing operations of the present disclosure may be written by one or more program design languages or a combination thereof, the program design languages comprising, but not limited to, object-oriented program design languages, such as Java, Smalltalk, C++, etc., as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the circumstance involving the remote computer, the remote computer may be connected to the user computer through any kind of network, comprising local area network (LAN) or wide area network (WAN), or connected to external computer (for example using an internet service provider via Internet).

The flowcharts and block diagrams in the drawings illustrate the architecture, functionality, and operation of some possible implementations of systems, methods and computer program products according to various embodiments of the present disclosure. In this regard, each block in the flowchart or block diagrams may represent a module, segment, or portion of code, which comprises one or more executable instructions for implementing the specified logical functions. It should also be noted that, in some alternative implementations, the functions noted in the block may occur out of the order noted in the drawings. For example, two blocks shown in succession may be executed substantially in parallel, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments described in the present disclosure can be implemented in software or hardware. The names of the units do not constitute a limitation on the units themselves under certain circumstances.

The functions described above may be performed at least in part by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), etc.

In the context of the present disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of thereof. More specific examples of the machine-readable storage medium may comprise electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

According to one or more embodiments of the present disclosure, the present disclosure provides an image processing method, comprising: determining N text regions and M text pattern types of an image to be processed, wherein N and M are integers greater than or equal to 1, and N is greater than or equal to M; rendering one or more text regions of the N text regions by using one or more text pattern types of the M text pattern types to obtain one or more first rendered images; inputting the one or more first rendered images into a scoring model to obtain scores of the one or more first rendered images; and determining a target image based on the scores of the one or more first rendered images.

According to one or more embodiments of the present disclosure, the present disclosure provides an image processing method, wherein the determining of the N text regions of the image to be processed comprises: determining a category of the image to be processed; determining a target template based on the category of the image to be processed; and determining the N text regions of the image to be processed based on the target template.

According to one or more embodiments of the present disclosure, the present disclosure provides an image processing method, wherein the determining of the target template based on the category of the image to be processed comprises: determining a template candidate set based on the category of the image to be processed and template information; and selecting the target template corresponding to the image to be processed from the template candidate set.

According to one or more embodiments of the present disclosure, the present disclosure provides an image processing method, wherein the template comprises a template background image, and accordingly, the selecting of the target template corresponding to the image to be processed from the template candidate set comprises: determining an image matching degree between the template background image and the image to be processed for one or more templates in the template candidate set; determining an image-text matching degree between the template information and the image to be processed; and determining the target template corresponding to the image to be processed based on the image matching degree and/or the image-text matching degree.

According to one or more embodiments of the present disclosure, the present disclosure provides an image processing method, wherein the determining of the N text regions of the image to be processed based on the target template comprises: determining a text region candidate set based on a text region of a background image of the target template; rendering one or more text candidate regions in the text region candidate set to obtain one or more second rendered images; and determining the N text regions based on texture complexities of the one or more second rendered images.

According to one or more embodiments of the present disclosure, the present disclosure provides an image processing method, wherein the determining of the N text regions based on texture complexities of the one or more second rendered images comprises: for the one or more second rendered images, determining the texture complexities of the text candidate regions of the one or more second rendered images; inputting the one or more second rendered images into the scoring model to obtain first scoring results; and determining the N text regions based on the texture complexities and the first scoring results.

According to one or more embodiments of the present disclosure, the present disclosure provides an image processing method, wherein the determining of the N text regions based on the texture complexities and the first scoring results comprises: for the one or more second rendered images, determining first weighted values calculated based on the texture complexities and the first scoring results; sorting the first weighted values in descending order; and determining text candidate regions corresponding to top N first weighted values as the text regions.

According to one or more embodiments of the present disclosure, the present disclosure provides an image processing method, wherein each of the M text pattern types comprises text color; and the determining of the M text pattern types of the image to be processed comprises: transforming the image to be processed to make the image to be processed be in HSV color space; obtaining hue values in the HSV color space for one or more pixel points in the image to be processed; determining a text color candidate set based on the hue values of the one or more pixel points; and selecting M text colors from the text color candidate set.

According to one or more embodiments of the present disclosure, the present disclosure provides an image processing method, wherein the selecting of the M text colors from the text color candidate set comprises: rendering the one or more text regions by using one or more text candidate colors in the text color candidate set to obtain a plurality of third rendered images; and determining the M text colors based on background contrasts of the plurality of third rendered images.

According to one or more embodiments of the present disclosure, the present disclosure provides an image processing method, wherein the determining of the M text colors based on the background contrasts of the plurality of third rendered images comprises: for one or more third rendered images, determining the background contrasts of the text regions in the one or more third rendered images; inputting the one or more third rendered images into the scoring model to obtain second scoring results; determining second weighted values calculated based on the background contrasts and the second scoring results; and determining the M text colors corresponding to the text regions based on the second weighted values.

According to one or more embodiments of the present disclosure, the present disclosure provides an image processing method, wherein a training method for the scoring model comprises: performing data labeling on a sample image based on an image quality of the sample image; and performing training using the sample image after data labeling to obtain the scoring model.

According to one or more embodiments of the present disclosure, the present disclosure provides an image processing apparatus, comprising: a text region and color determination module configured to determine N text regions and M text pattern types of an image to be processed, wherein N and M are integers greater than or equal to 1, and N is greater than or equal to M; a first rendering module configured to render one or more text regions of the N text regions by using one or more text pattern types of the M text pattern types to obtain one or more first rendered images; a score determination module configured to input the one or more first rendered images into a scoring model to obtain scores of the one or more first rendered images; and a target image determination module configured to determine a target image based on the scores of the one or more first rendered images.

According to one or more embodiments of the present disclosure, the present disclosure provides an image processing apparatus, the text region and color determination module comprises a text region determination module and a text pattern type determination module; the text region determination module comprises: an image category determination unit configured to determine a category of the image to be processed; a target template determination unit configured to determine a target template based on the category of the image to be processed; and a text region determination unit configured to determine the N text regions of the image to be processed based on the target template.

According to one or more embodiments of the present disclosure, the present disclosure provides an image processing apparatus, wherein the target template determination unit is configured to determine a template candidate set based on the category of the image to be processed and template information, and select the target template corresponding to the image to be processed from the template candidate set.

According to one or more embodiments of the present disclosure, the present disclosure provides an image processing apparatus, wherein the template comprises a template background image; and the target template determination unit is configured to determine an image matching degree between the template background image and the image to be processed for one or more templates in the template candidate set, determine an image-text matching degree between the template information and the image to be processed, and determine the target template corresponding to the image to be processed based on the image matching degree and/or the image-text matching degree.

According to one or more embodiments of the present disclosure, the present disclosure provides an image processing apparatus, wherein the text region determination unit is configured to determine a text region candidate set based on a text region of a background image of the target template, render one or more text candidate regions in the text region candidate set to obtain one or more second rendered images, and determine the N text regions based on texture complexities of the one or more second rendered images.

According to one or more embodiments of the present disclosure, the present disclosure provides an image processing apparatus, wherein the text region determination unit is configured to determine the N text regions based on the texture complexities of the one or more second rendered images, comprising: for the one or more second rendered images, determining the texture complexities of the text candidate regions of the one or more second rendered images; inputting the one or more second rendered images into the scoring model to obtain first scoring results; and determining the N text regions based on the texture complexities and the first scoring results.

According to one or more embodiments of the present disclosure, the present disclosure provides an image processing apparatus, wherein the text region determination unit is configured to, for the one or more second rendered images, determine first weighted values calculated based on the texture complexities and the first scoring results, sort the first weighted values in descending order, and determine text candidate regions corresponding to top N first weighted values as the text regions.

According to one or more embodiments of the present disclosure, the present disclosure provides an image processing apparatus, wherein the text pattern type determination module comprises: an image transforming unit configured to transform the image to be processed to make the image to be processed be in HSV color space; a hue value extraction unit configured to obtain hue values in the HSV color space for one or more pixel points in the image to be processed; a text color candidate set determination unit configured to determine a text color candidate set based on the hue values of the one or more pixel points; and a text color determination unit configured to select M text colors from the text color candidate set.

According to one or more embodiments of the present disclosure, the present disclosure provides an image processing apparatus, wherein the text color determination unit is configured to select the M text colors from the text color candidate set, comprising: rendering the one or more text regions by using one or more text candidate colors in the text color candidate set to obtain a plurality of third rendered images; and determining the M text colors based on background contrasts of the plurality of third rendered images.

According to one or more embodiments of the present disclosure, the present disclosure provides an image processing apparatus, wherein the text color determination unit is configured to, for one or more third rendered images, determine the background contrasts of the text regions in the one or more third rendered images, input the one or more third rendered images into the scoring model to obtain second scoring results, determine second weighted values calculated based on the background contrasts and the second scoring results, and determine the M text colors corresponding to the text regions based on the second weighted values.

According to one or more embodiments of the present disclosure, the present disclosure provides an image processing apparatus, comprising a scoring module training module configured to perform data labeling on a sample image based on an image quality of the sample image, and perform training using the sample image after data labeling to obtain the scoring model.

According to one or more embodiments of the present disclosure, the present disclosure provides an electronic device, comprising: one or more processors; a memory configured to store one or more programs that, when executed by the one or more processors, cause the one or more processors to implement the image processing method provided by any embodiments of the present disclosure.

According to one or more embodiments of the present disclosure, the present disclosure provides a computer-readable medium stored thereon a computer program that, when executed by a processor, implements the image processing method provided by any embodiments of the present disclosure.

An embodiment of the present disclosure further provides a computer program product comprising computer programs or instructions that, when executed by a processor, implement the above image processing method.

An embodiment of the present disclosure further provides a computer program, comprising: instructions that, when executed by a processor, cause the processor to perform the image processing method described above.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the disclosed concept, for example, technical solutions formed by replacing the above features with technical features having similar functions to (but not limited to) those disclosed in the present disclosure.

In addition, although the operations are depicted in a specific order, this should not be understood as requiring these operations to be performed in the specific order shown or performed in a sequential order. Under certain circumstances, multitasking and parallel processing may be advantageous. Likewise, although several specific implementation details are comprised in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable subcombination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. An image processing method, comprising:
determining N text regions and M text pattern types of an image to be processed, wherein N and M are integers greater than or equal to 1, and N is greater than or equal to M;
rendering one or more text regions of the N text regions by using one or more text pattern types of the M text pattern types to obtain one or more first rendered images;
inputting the one or more first rendered images into a scoring model to obtain scores of the one or more first rendered images; and
determining a target image based on the scores of the one or more first rendered images.

2. The image processing method according to claim 1, wherein the determining of the N text regions of the image to be processed comprises:
determining a category of the image to be processed;
determining a target template based on the category of the image to be processed; and
determining the N text regions of the image to be processed based on the target template.

3. The image processing method according to claim 2, wherein the determining of the target template based on the category of the image to be processed comprises:
determining a template candidate set based on the category of the image to be processed and template information; and
selecting the target template corresponding to the image to be processed from the template candidate set.

4. The image processing method according to claim 3, wherein
a template in the template candidate set comprises a template background image, and the selecting of the target template corresponding to the image to be processed from the template candidate set comprises:
determining an image matching degree between the template background image and the image to be processed for one or more templates in the template candidate set;
determining an image-text matching degree between the template information and the image to be processed; and
determining the target template corresponding to the image to be processed based on the image matching degree and/or the image-text matching degree.

5. The image processing method according to claim 2, wherein the determining of the N text regions of the image to be processed based on the target template comprises:
determining a text region candidate set based on a text region of a background image of the target template;
rendering one or more text candidate regions in the text region candidate set to obtain one or more second rendered images; and
determining the N text regions based on texture complexities of the one or more second rendered images.

6. The image processing method according to claim 5, wherein the determining of the N text regions based on texture complexities of the one or more second rendered images comprises:
for the one or more second rendered images, determining the texture complexities of the text candidate regions of the one or more second rendered images;
inputting the one or more second rendered images into the scoring model to obtain first scoring results; and
determining the N text regions based on the texture complexities and the first scoring results.

7. The image processing method according to claim 6, wherein the determining of the N text regions based on the texture complexities and the first scoring results comprises:
for the one or more second rendered images, determining first weighted values calculated based on the texture complexities and the first scoring results;
sorting the first weighted values in descending order; and
determining text candidate regions corresponding to top N first weighted values as the text regions.

8. The image processing method according to claim 1, wherein:
each of the M text pattern types comprises text color; and
the determining of the M text pattern types of the image to be processed comprises:
transforming the image to be processed to make the image to be processed be in HSV color space;
obtaining hue values in the HSV color space for one or more pixel points in the image to be processed;
determining a text color candidate set based on the hue values of the one or more pixel points; and
selecting M text colors from the text color candidate set.

9. The image processing method according to claim 8, wherein the selecting of the M text colors from the text color candidate set comprises:
rendering the one or more text regions by using one or more text candidate colors in the text color candidate set to obtain a plurality of third rendered images; and
determining the M text colors based on background contrasts of the plurality of third rendered images.

10. The image processing method according to claim 9, wherein the determining of the M text colors based on the background contrasts of the plurality of third rendered images comprises:
for one or more third rendered images of the plurality of third rendered images, determining the background contrasts of the text regions in the one or more third rendered images;
inputting the one or more third rendered images into the scoring model to obtain second scoring results;
determining second weighted values calculated based on the background contrasts and the second scoring results; and
determining the M text colors corresponding to the text regions based on the second weighted values.

11. The image processing method according to claim 1, wherein a training method for the scoring model comprises:
performing data labeling on a sample image based on an image quality of the sample image; and
performing training using the sample image after data labeling to obtain the scoring model.

12. (canceled)

13. An electronic device, comprising:
one or more processors; and
a storage device configured to store one or more programs that, when executed by the one or more processors, cause the one or more processors to
determine N text regions and M text pattern types of an image to be processed, wherein N and M are integers greater than or equal to 1, and N is greater than or equal to M:
render one or more text regions of the N text regions by using one or more text pattern types of the M text pattern types to obtain one or more first rendered images:
input the one or more first rendered images into a scoring model to obtain scores of the one or more first rendered images; and
determine a target image based on the scores of the one or more first rendered images.

14. A non-transitory computer-readable storage medium stored thereon a computer program that, when executed by a processor, causes the processor to:
determine N text regions and M text pattern types of an image to be processed, wherein N and M are integers greater than or equal to 1, and N is greater than or equal to M:
render one or more text regions of the N text regions by using one or more text pattern types of the M text pattern types to obtain one or more first rendered images:
input the one or more first rendered images into a scoring model to obtain scores of the one or more first rendered images; and
determine a target image based on the scores of the one or more first rendered images.

15-16. (canceled)

17. The electronic device according to claim 13, wherein the one or more programs that, when executed by the one or more processors, cause the one or more processors to:
determine a category of the image to be processed;
determine a target template based on the category of the image to be processed; and
determine the N text regions of the image to be processed based on the target template.

18. The electronic device according to claim 17, wherein the one or more programs that, when executed by the one or more processors, cause the one or more processors to:
determine a template candidate set based on the category of the image to be processed and template information; and
select the target template corresponding to the image to be processed from the template candidate set.

19. The electronic device according to claim 18, wherein a template in the template candidate set comprises a template background image, and
the one or more programs that, when executed by the one or more processors, cause the one or more processors to:
determine an image matching degree between the template background image and the image to be processed for one or more templates in the template candidate set;
determine an image-text matching degree between the template information and the image to be processed; and
determine the target template corresponding to the image to be processed based on the image matching degree and/or the image-text matching degree.

20. The electronic device according to claim 17, wherein the one or more programs that, when executed by the one or more processors, cause the one or more processors to:
determine a text region candidate set based on a text region of a background image of the target template;
render one or more text candidate regions in the text region candidate set to obtain one or more second rendered images; and
determine the N text regions based on texture complexities of the one or more second rendered images.

21. The non-transitory computer-readable storage medium according to claim 14, wherein the computer program that, when executed by the processor, causes the processor to:
determine a category of the image to be processed;
determine a target template based on the category of the image to be processed; and
determine the N text regions of the image to be processed based on the target template.

22. The non-transitory computer-readable storage medium according to claim 21, wherein the computer program that, when executed by the processor, causes the processor to:
determine a template candidate set based on the category of the image to be processed and template information; and
select the target template corresponding to the image to be processed from the template candidate set.

23. The non-transitory computer-readable storage medium according to claim 22, wherein a template in the template candidate set comprises a template background image, and
the computer program that, when executed by the processor, causes the processor to:
determine an image matching degree between the template background image and the image to be processed for one or more templates in the template candidate set;
determine an image-text matching degree between the template information and the image to be processed; and
determine the target template corresponding to the image to be processed based on the image matching degree and/or the image-text matching degree.
